(19) United States
(12) Patent Application Publication
(10) Pub. No.: US 2012/0286853 A1
(43) Pub. Date: Nov. 15, 2012

(54) SEMICONDUCTOR INTEGRATED CIRCUIT

(75) Inventors: Ryouhei SEKI, Osaka (JP); Hideyuki Kabuo, Kyoto (JP)

(73) Assignee: PANASONIC CORPORATION, Osaka (JP)

(21) Appl. No.: 13/559,403

(22) Filed: Jul. 26, 2012

Related U.S. Application Data
(63) Continuation of application No. PCT/JP2010/006298, filed on Oct. 25, 2010.

(30) Foreign Application Priority Data
Feb. 26, 2010 (JP) 2010-042214

(51) Int. Cl. G05F 1/10

(52) U.S. Cl. 327/535; 327/534

(57) ABSTRACT

A semiconductor integrated circuit includes a main circuit including a transistor, a pseudo-power supply line connected to a first power supply terminal of the main circuit, a first power supply line connected to the pseudo-power supply line via a first switch, a second power supply line connected to a second power supply terminal of the main circuit, a diode having a first end connected to the pseudo-power supply line and a second end connected to the first power supply line so that a potential difference between the pseudo-power supply line and the second power supply line is reduced in a conductive state, and a second switch having a first end connected to the pseudo-power supply line and a second end connected to the second power supply line.

### CROSS-REFERENCE TO RELATED APPLICATIONS

This is a continuation of PCT International Application PCT/JP2010/006298 filed on Oct. 25, 2010, which claims priority to Japanese Patent Application No. 2010-042214 filed on Feb. 26, 2010. The disclosures of these applications including the specifications, the drawings, and the claims are hereby incorporated by reference in their entirety.

### BACKGROUND

The present disclosure relates to techniques of reducing the power consumption of a semiconductor integrated circuit including a transistor when the operation is stopped.

In recent years, due to advances in miniaturization of MOS transistors, there has been a problem that a leakage current flowing in a semiconductor integrated circuit has a significant influence on the power consumption. In order to reduce the leakage current, the power supply voltage may be lowered or the substrate voltage may be applied when the circuit is not operating, i.e., in the standby state. Alternatively, in the standby state, power supply to a target circuit may be cut off after data is stored in another circuit or memory.

Japanese Patent Publication No. H09-321600 describes the following technique. In order to reduce power consumption caused by a current passing through logic circuits connected to a high-potential pseudo-power supply line and a low-potential power supply line, the potential of the pseudo-power supply line is rapidly changed when power supply to the logic circuits is cut off, whereby the output potentials of logic gates included in the logic circuits are quickly settled.

### SUMMARY

The present disclosure describes implementations of a semiconductor integrated circuit in which a power supply voltage supplied to the main circuit is lowered in the standby state, and the power consumption is reduced by quickly reducing a leakage current in the main circuit.

A semiconductor integrated circuit according to an embodiment of the present disclosure includes a main circuit including a transistor, a pseudo-power supply line connected to a first power supply terminal of the main circuit, a first power supply line connected to the pseudo-power supply line via a first switch, a second power supply line connected to a second power supply terminal of the main circuit, a diode having a first end connected to the pseudo-power supply line and a second end connected to the first power supply line so that a potential difference between the pseudo-power supply line and the second power supply line is reduced in a conductive state, and a second switch having a first end connected to the pseudo-power supply line and a second end connected to the second power supply line.

According to this embodiment, when the first switch is opened to transition to a state in which a current is supplied to the main circuit via the diode, the second switch is closed to connect the pseudo-power supply line and the second power supply line together, whereby the potential difference between the pseudo-power supply line and the second power supply line can be rapidly decreased. As a result, a leakage current flowing in the main circuit connected to the pseudo-power supply line and the second power supply line can be rapidly decreased, resulting in a reduction in power consumption.

According to the present disclosure, the leakage current flowing in the main circuit can be rapidly decreased, whereby the power consumption can be reduced.

### BRIEF DESCRIPTION OF THE DRAWINGS

FIG. 1 is a circuit diagram showing a configuration of a semiconductor integrated circuit according to a first embodiment of the present disclosure.

FIG. 2 is a timing chart showing the potentials of control signal lines EN1 and EN2, the potential of a pseudo-power supply line VA, and the sum of the leakage current of a main circuit according to the first embodiment of the present disclosure and the current of a P-channel MOS transistor MS2, during a period of time that the main circuit transitions from the active state to the standby state and then back to the active state.

FIG. 3 is a timing chart showing the potentials of control signal lines EN1 and EN2, the potential of a pseudo-power supply line VA, and the sum of the leakage current of a main circuit according to a second embodiment of the present disclosure and the current of a P-channel MOS transistor MS2, during a period of time that the main circuit transitions from the active state to the standby state and then back to the active state.

FIG. 4 is a circuit diagram showing a configuration of a semiconductor integrated circuit according to a third embodiment of the present disclosure.

FIG. 5 is a timing chart showing the potentials of control signal lines EN1 and EN2, the output potential of a potential determination circuit, the output potential of a control circuit, and the potential of a pseudo-power supply line VA, during a period of time that a main circuit according to the third embodiment of the present disclosure transitions from the active state to the standby state and then back to the active state.

FIG. 6 is a circuit diagram showing a configuration of a semiconductor integrated circuit according to a fourth embodiment of the present disclosure.

FIG. 7 is a timing chart showing the potentials of control signal lines EN1 and EN2, the output potential of a potential determination circuit, the output potential of a control circuit, and the potential of a pseudo-power supply line VA, during a period of time that a main circuit according to the fourth embodiment of the present disclosure transitions from the active state to the standby state and then back to the active state.

### DETAILED DESCRIPTION

Embodiments of the present disclosure will be described hereinafter with reference to the accompanying drawings.

### First Embodiment

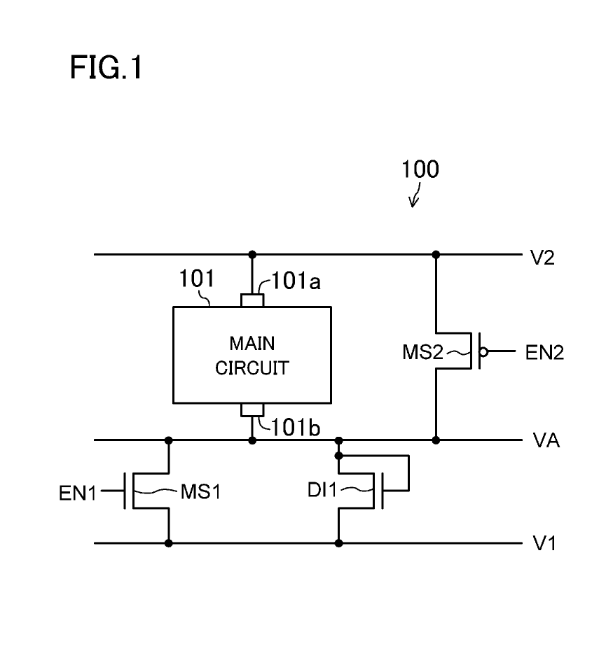

FIG. 1 shows a semiconductor integrated circuit 100 according to a first embodiment of the present disclosure.

The semiconductor integrated circuit 100 includes a main circuit 101 including transistors. The main circuit 101 has a high-potential power supply terminal 101a and a low-potential power supply terminal 101b. A pseudo-power supply line VA is connected to the low-potential power supply terminal 101b. A low-potential power supply line V1 is connected to the pseudo-power supply line VA via an N-channel MOS transistor MS1 serving as a switch. A control signal line EN1 is connected to the gate of the N-channel MOS transistor MS1. The conduction of the N-channel MOS transistor MS1 is controlled based on a control signal transmitted through the control signal line EN1.

A high-potential power supply line V2 is connected to the high-potential power supply terminal 101a of the main circuit 101. A P-channel MOS transistor MS2 serving as a switch is connected, in parallel to the main circuit 101, to the high-potential power supply line V2 and the pseudo-power supply line VA. Specifically, the drain (one end) of the P-channel MOS transistor MS2 is connected to the pseudo-power supply line VA while the source (the other end) of the P-channel MOS transistor MS2 is connected to the high-potential power supply line V2. A control signal line EN2 is connected to the gate of the P-channel MOS transistor MS2. The conduction of the P-channel MOS transistor MS2 is controlled based on a control signal transmitted through the control signal line EN2.

A diode DI1 is connected, in parallel to the N-channel MOS transistor MS1, to the low-potential power supply line V1 and the pseudo-power supply line VA in order to reduce a potential difference between the pseudo-power supply line VA and the high-potential power supply line V2 in the conductive state. Specifically, one end of the diode DI1 is connected to the pseudo-power supply line VA while the other end of the diode DI1 is connected to the low-potential power supply line V1.

In an active state in which the main circuit 101 performs desired operation, the N-channel MOS transistor MS1 is put into the conductive state (closed state) based on a control signal transmitted through the control signal line EN1. As a result, the potential of the pseudo-power supply line VA is substantially equal to the potential of the low-potential power supply line V1, so that a current is supplied to the main circuit 101. At this time, the P-channel MOS transistor MS2 is put into the non-conductive state (open state) based on a control signal transmitted through the control signal line EN2.

On the other hand, in a standby state in which the main circuit 101 does not operate, the N-channel MOS transistor MS1 is put into the non-conductive state (opened) based on a control signal transmitted through the control signal line EN1. At this time, the P-channel MOS transistor MS2 is put into the conductive state (closed) based on a control signal transmitted through the control signal line EN2, so that the potential of the pseudo-power supply line VA increases rapidly. As a result, the pseudo-power supply line VA is charged by a leakage current of the main circuit 101 and a current flowing through the P-channel MOS transistor MS2, so that the potential of the pseudo-power supply line VA increases. The potential of the pseudo-power supply line VA increases until the sum of the leakage current of the main circuit 101 and the current flowing through the P-channel MOS transistor MS2 becomes equal to the current of the diode DI1. Thus, the potential of the pseudo-power supply line VA increases, so that the potential difference between the pseudo-power supply line VA and the high-potential power supply line V2 decreases, and therefore, the leakage current of the main circuit 101 decreases rapidly.

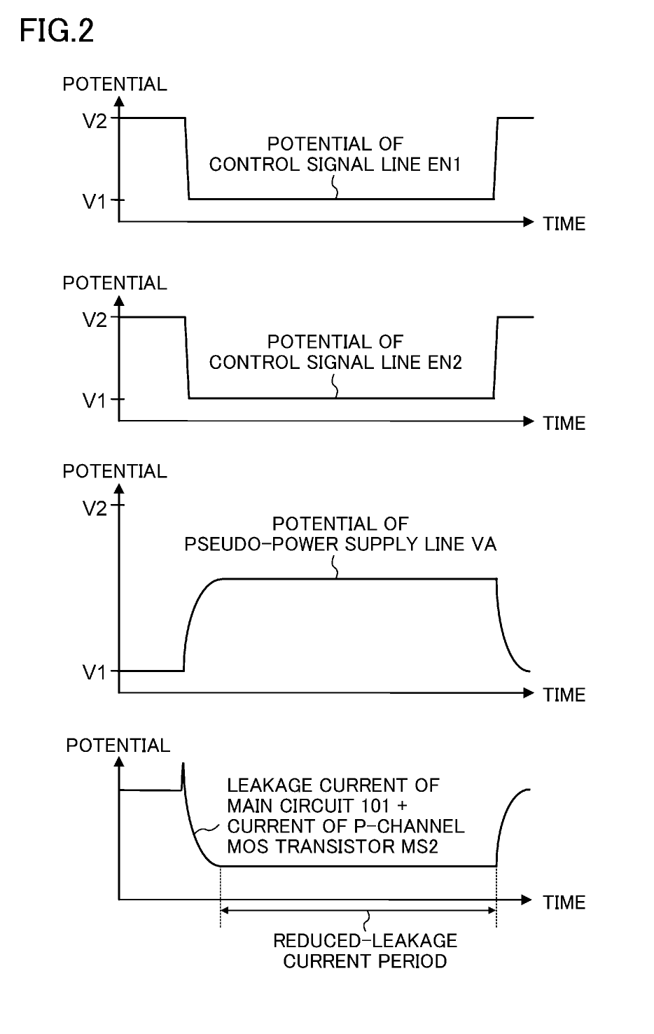

FIG. 2 shows the potentials of the control signal lines EN1 and EN2, the potential of the pseudo-power supply line VA, and the sum of the leakage current of the main circuit 101 and the current of the P-channel MOS transistor MS2, during a period of time that the main circuit 101 transitions from the active state to the standby state and then back to the active state.

In the active state, the potentials of the control signal lines EN1 and EN2 are caused to be equal to the potential of the high-potential power supply line V2. When the main circuit 101 transitions from the active state to the standby state, the potential of the control signal line EN1 is lowered to the potential of the low-potential power supply line V1 so that the N-channel MOS transistor MS1 is put into the non-conductive state. At the same time, the potential of the control signal line EN2 is lowered to the potential of the low-potential power supply line V1 so that the P-channel MOS transistor MS2 is put into the conductive state. As a result, the potential of the pseudo-power supply line VA increases rapidly. Due to the increase in the potential of the pseudo-power supply line VA, the leakage current of the main circuit 101 and the current of the P-channel MOS transistor MS2 decrease rapidly. Because the increase of the potential of the pseudo-power supply line VA is completed quickly, a period of time that the leakage current of the main circuit 101 is kept at the minimum value increases, resulting in an improvement in the power consumption reduction effect.

Note that transistors other than the N-channel MOS transistor MS1 and the P-channel MOS transistor MS2 may be used as switches.

### Second Embodiment

A semiconductor integrated circuit 100 according to a second embodiment is different from the semiconductor integrated circuit 100 of the first embodiment in that the P-channel MOS transistor MS2 is put into the non-conductive state before returning to the active state (i.e., before the N-channel MOS transistor MS1 is put into the conductive state) for the first time after transition from the active state to the standby state. In other respects, the semiconductor integrated circuit 100 of the second embodiment is the same as the semiconductor integrated circuit 100 of the first embodiment.

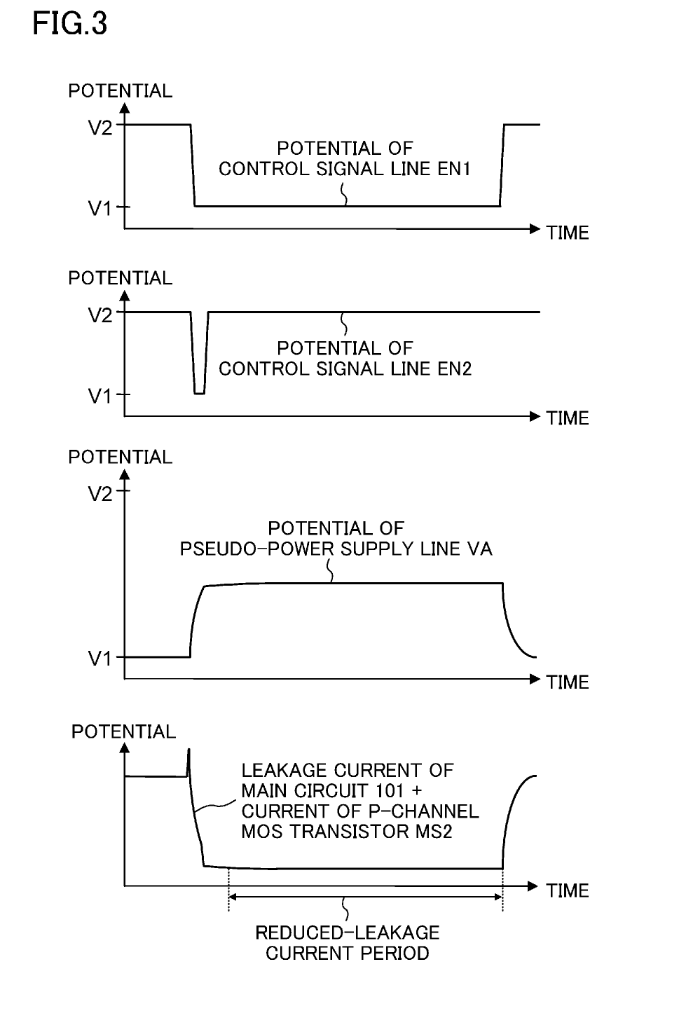

FIG. 3 shows the potentials of the control signal lines EN1 and EN2, the potential of the pseudo-power supply line VA, and the sum of the leakage current of the main circuit 101 and the current of the P-channel MOS transistor MS2, during a period of time that the main circuit 101 transitions from the active state to the standby state and then back to the active state.

In the active state, the potentials of the control signal lines EN1 and EN2 are caused to be equal to the potential of the high-potential power supply line V2. When the main circuit 101 transitions to the standby state, the potential of the control signal line EN1 is lowered to the potential of the low-potential power supply line V1 so that the N-channel MOS transistor MS1 is put into the non-conductive state. At the same time, the potential of the control signal line EN2 is lowered to the potential of the low-potential power supply line V1 so that the P-channel MOS transistor MS2 is put into the conductive state. As a result, the potential of the pseudo-power supply line VA increases rapidly. After a predetermined period of time has elapsed, the potential of the control signal line EN2 is raised back to the potential of the high-potential power supply line V2 so that the P-channel MOS transistor MS2 is put into the non-conductive state. As a result, the potential of the pseudo-power supply line VA gradually increases to a saturated level. Thus, while the leakage current of the main circuit 101 is rapidly decreased, the current of the P-channel MOS transistor MS2 can be reduced. Also, the potential of the pseudo-power supply line VA is saturated without being excessively increased, whereby the disappearance of a signal state held by the main circuit 101 can be reduced or prevented.

### Third Embodiment

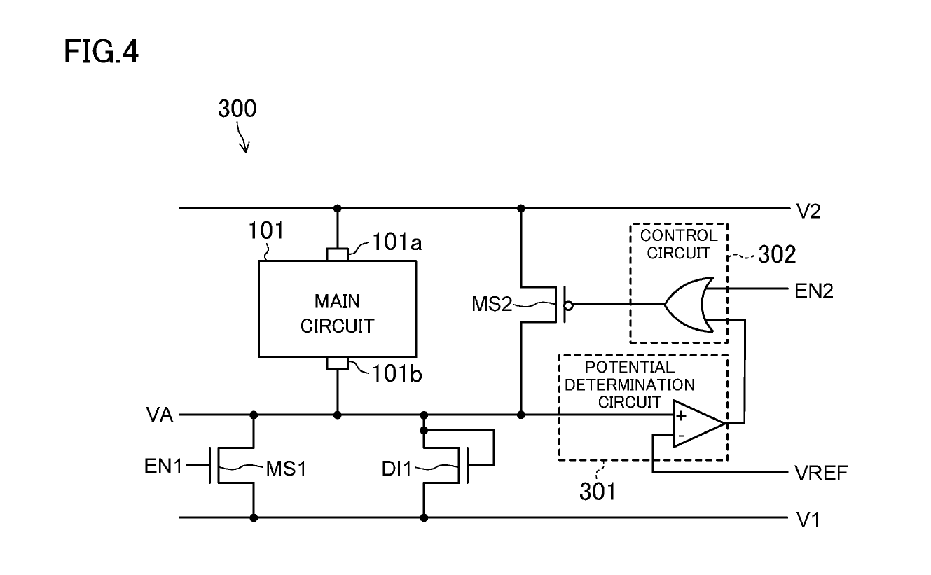

FIG. 4 shows a semiconductor integrated circuit 300 according to a third embodiment of the present disclosure.

The semiconductor integrated circuit 300 includes a potential determination circuit 301 and a control circuit 302 in addition to the components of the semiconductor integrated circuit 100 of the first embodiment.

The potential determination circuit 301 is a potential comparator which is connected to the pseudo-power supply line VA and a reference potential power supply line VREF, and determines whether or not the potential of the pseudo-power supply line VA has reached the potential of the reference potential power supply line VREF. If the potential of the pseudo-power supply line VA has reached the potential of the reference potential power supply line VREF, the potential determination circuit 301 outputs a determination signal having the potential (high level) of the high-potential power supply line V2. If the potential of the pseudo-power supply line VA has not reached the potential of the reference potential power supply line VREF, the potential determination circuit 301 outputs a determination signal having the potential (low level) of the low-potential power supply line V1.

The control circuit 302 is an OR circuit (logic circuit) which outputs a logical OR of the signal of the control signal line EN2 (a signal having the same level as the potential of the control signal line EN1) and the determination signal output by the potential determination circuit 301. If the potential of the pseudo-power supply line VA has reached the potential of the reference potential power supply line VREF, the control circuit 302 puts the P-channel MOS transistor MS2 into the non-conductive state (open state).

In other respects, the semiconductor integrated circuit 300 of the third embodiment is the same as the semiconductor integrated circuit 100 of the first embodiment.

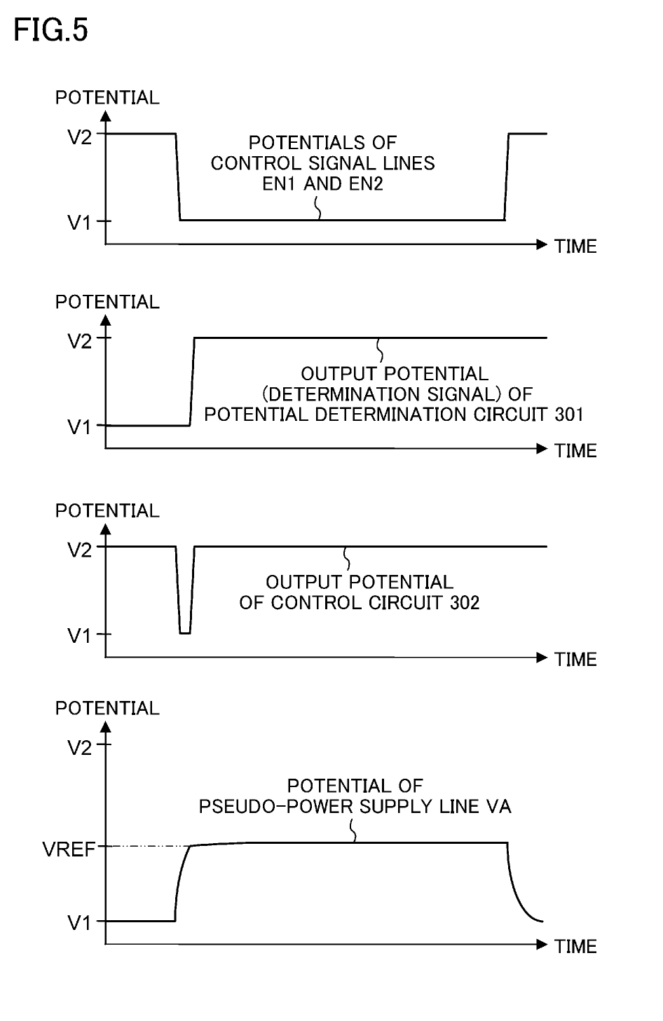

FIG. 5 shows the potentials of the control signal lines EN1 and EN2, the output potential of the potential determination circuit 301, the output potential of the control circuit 302, and the potential of the pseudo-power supply line VA, during a period of time that the main circuit 101 transitions from the active state to the standby state and then back to the active state.

In the active state, the potentials of the control signal lines EN1 and EN2 are caused to be equal to the potential of the high-potential power supply line V2. Therefore, the output potential of the control circuit 302 is equal to the potential of the high-potential power supply line V2. At this time, the potential of the pseudo-power supply line VA is substantially equal to the potential of the low-potential power supply line V1 and is lower than the potential of the reference potential power supply line VREF. Therefore, the output potential of the potential determination circuit 301 is equal to the potential of the low-potential power supply line V1.

When the main circuit 101 transitions to the standby state, the potential of the control signal line EN1 is lowered to the potential of the low-potential power supply line V1 so that the N-channel MOS transistor MS1 is put into the non-conductive state. At the same time, the potential of the control signal line EN2 is lowered to the potential of the low-potential power supply line V1 so that the output potential of the control circuit 302 becomes equal to the potential of the low-potential power supply line V1. As a result, the P-channel MOS transistor MS2 is put into the conductive state, and the potential of the pseudo-power supply line VA increases rapidly. Thereafter, when the potential of the pseudo-power supply line VA has reached the potential of the reference potential power supply line VREF, the output potential of the potential determination circuit 301 becomes equal to the potential of the high-potential power supply line V2, and the output potential of the control circuit 302 becomes equal to the potential of the high-potential power supply line V2. As a result, the P-channel MOS transistor MS2 is put into the non-conductive state, and the increase of the potential of the pseudo-power supply line VA becomes mild. Thereafter, the potential of the pseudo-power supply line VA is saturated. By this series of operation, in the standby state, while the leakage current of the main circuit is rapidly reduced, the current of the P-channel MOS transistor MS2 can be reduced. Also, the potential of the pseudo-power supply line VA is saturated without being excessively increased from the potential of the reference potential power supply line VREF, whereby the disappearance of a signal state held by the main circuit can be reduced or prevented.

### Fourth Embodiment

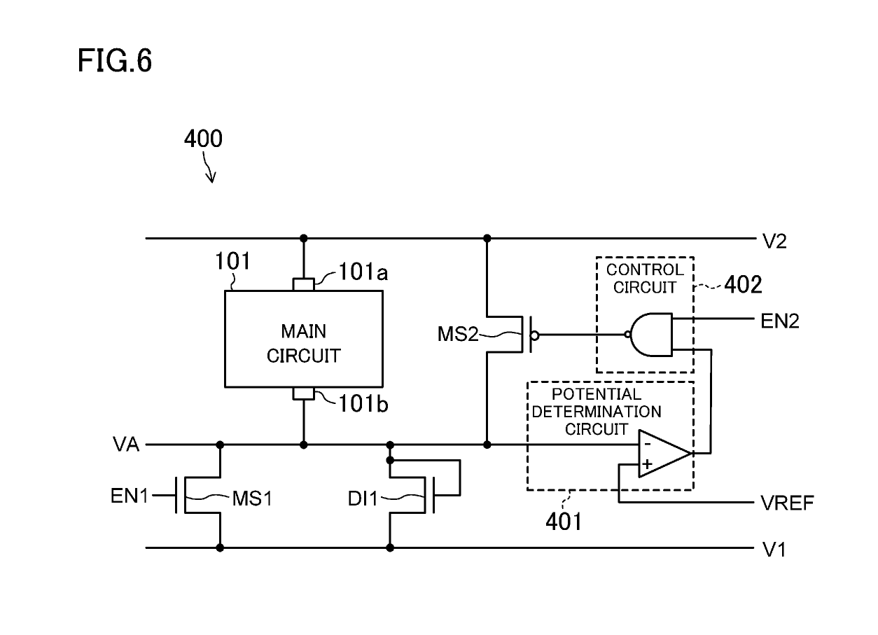

FIG. 6 shows a semiconductor integrated circuit 400 according to a fourth embodiment of the present disclosure.

The semiconductor integrated circuit 400 is different from the semiconductor integrated circuit 300 of the third embodiment in that a potential determination circuit 401 is provided instead of the potential determination circuit 301, and a control circuit 402 is provided instead of the control circuit 302.

The potential determination circuit 401 is a potential comparator which is connected to the pseudo-power supply line VA and the reference potential power supply line VREF, and determines whether or not the potential of the pseudo-power supply line VA has reached the potential of the reference potential power supply line VREF. If the potential of the pseudo-power supply line VA has reached the potential of the reference potential power supply line VREF, the potential determination circuit 401 outputs a determination signal having the potential (low level) of the low-potential power supply line V1. If the potential of the pseudo-power supply line VA has not reached the potential of the reference potential power supply line VREF, the potential determination circuit 401 outputs a determination signal having the potential (high level) of the high-potential power supply line V2.

The control circuit 402 is a NAND circuit (logic circuit) which outputs a logical negated AND of the signal of the control signal line EN2 (a signal having a level opposite to the potential of the control signal line EN1) and the determination signal output by the potential determination circuit 401. If the potential of the pseudo-power supply line VA has reached the potential of the reference potential power supply line VREF, the control circuit 402 puts the P-channel MOS transistor MS2 into the non-conductive state (open state).

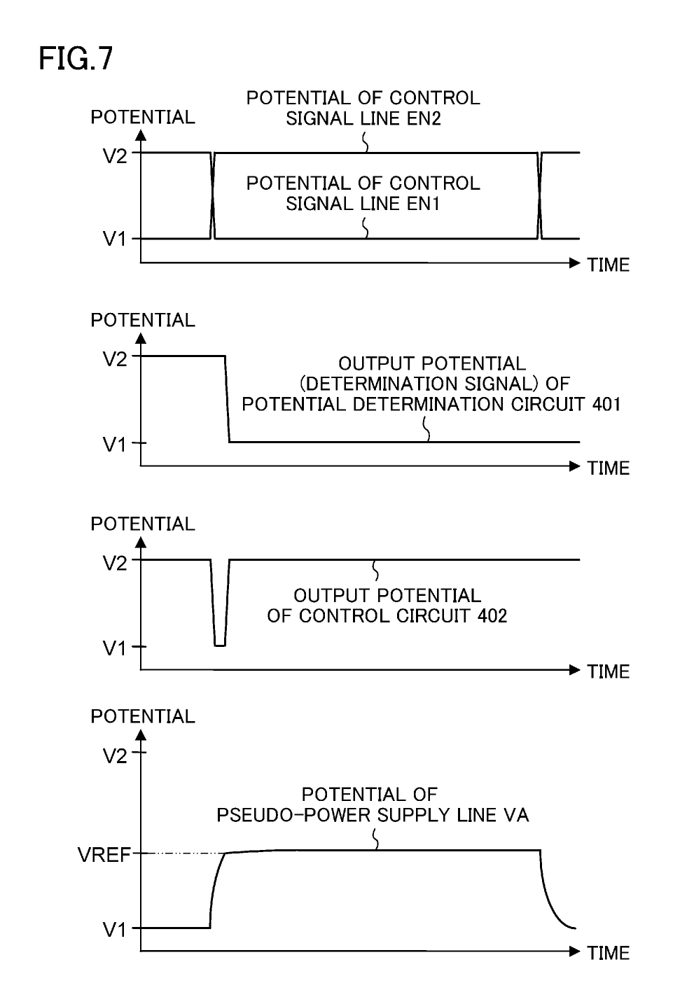

FIG. 7 shows the potentials of the control signal lines EN1 and EN2, the output potential of the potential determination circuit 401, the output potential of the control circuit 402, and the potential of the pseudo-power supply line VA, during a period of time that the main circuit 101 transitions from the active state to the standby state and then back to the active state.

In the active state, the potential of the control signal line EN1 is caused to be equal to the potential of the high-potential power supply line V2, and the potential of the control signal line EN2 is caused to be equal to the potential of the low-potential power supply line V1. At this time, the potential of the pseudo-power supply line VA is substantially equal to the potential of the low-potential power supply line V1 and is lower than the potential of the reference potential power supply line VREF. Therefore, the output potential of the potential determination circuit 401 is equal to the potential of the high-potential power supply line V2. As a result, the output potential of the control circuit 402 is equal to the potential of the high-potential power supply line V2.

When the main circuit 101 transitions to the standby state, the potential of the control signal line EN1 is lowered to the potential of the low-potential power supply line V1 so that the N-channel MOS transistor MS1 is put into the non-conductive state. At the same time, the potential of the control signal line EN2 is raised to the potential of the high-potential power supply line V2 so that the output potential of the control circuit 402 becomes equal to the potential of the low-potential power supply line V1. As a result, the P-channel MOS transistor MS2 is put into the conductive state, so that the potential of the pseudo-power supply line VA increases rapidly. When the potential of the pseudo-power supply line VA has reached the potential of the reference potential power supply line VREF, the output potential of the potential determination circuit 401 becomes equal to the potential of the low-potential power supply line V1, and the output potential of the control circuit 402 becomes equal to the potential of the high-potential power supply line V2. As a result, the P-channel MOS transistor MS2 is put into the non-conductive state, so that the potential of the pseudo-power supply line VA mildly increases to a saturated level. By this series of operation, in the standby state, while the leakage current of the main circuit 101 is rapidly reduced, the current of the P-channel MOS transistor MS2 can be reduced. Also, the potential of the pseudo-power supply line VA is saturated without being excessively increased from the potential of the reference potential power supply line VREF, whereby the disappearance of a signal state held by the main circuit can be reduced or prevented.

Although, in the third and fourth embodiments, a potential comparator is used as the potential determination circuits 301 and 401, any other circuit may be used that determines whether or not the potential of the pseudo-power supply line VA has reached a predetermined potential.

Although, in the third and fourth embodiments, an OR circuit and a NAND circuit are used as the control circuits 302 and 402, respectively, any other circuit may be used that puts the P-channel MOS transistor MS2 into the non-conductive state (open state) when the potential of the pseudo-power supply line VA has reached the potential of the reference potential power supply line VREF.

In the first to fourth embodiments, a pseudo-power supply line may be provided on the high-potential side of the main circuit 101, and a diode may be connected between the pseudo-power supply line and the high-potential power supply line in order to reduce the potential difference between the pseudo-power supply line and the low-potential power supply line when the diode is in the conductive state.

The semiconductor integrated circuit of the present disclosure is useful as a technique of reducing the power consumption when the operation is stopped.

What is claimed is:

1. A semiconductor integrated circuit comprising:
a main circuit including a transistor;
a pseudo-power supply line connected to a first power supply terminal of the main circuit;
a first power supply line connected to the pseudo-power supply line via a first switch;
a second power supply line connected to a second power supply terminal of the main circuit;
a diode having a first end connected to the pseudo-power supply line and a second end connected to the first power supply line so that a potential difference between the pseudo-power supply line and the second power supply line is reduced in a conductive state; and
a second switch having a first end connected to the pseudo-power supply line and a second end connected to the second power supply line.

2. The semiconductor integrated circuit of claim 1, wherein
when a state in which a current is supplied via the first switch to the main circuit while the first switch is closed and the second switch is open, transitions to a state in which a current is supplied via the diode to the main circuit while the first switch is open, the second switch is closed.

3. The semiconductor integrated circuit of claim 1, wherein
the first and second switches are controlled so that the second switch is closed while the first switch is open, and the second switch is open while the first switch is closed.

4. The semiconductor integrated circuit of claim 2, wherein
the first and second switches are controlled so that the second switch is open while the first switch is closed, and the second switch is open before the first switch is closed for the first time after the state transition.

5. The semiconductor integrated circuit of claim 1, further comprising:
a potential determination circuit configured to determine whether or not a potential of the pseudo-power supply line has reached a predetermined potential; and
a control circuit configured to open the second switch when the potential determination circuit determines that the potential of the pseudo-power supply line has reached the predetermined potential.

6. The semiconductor integrated circuit of claim 5, wherein
the potential determination circuit is a potential comparator connected to the pseudo-power supply line and a power supply line having the predetermined potential.

7. The semiconductor integrated circuit of claim 5, wherein
the potential determination circuit outputs a determination signal which is at a high level when the potential of the pseudo-power supply line has reached the predetermined potential and at a low level when the potential of the pseudo-power supply line has not reached the predetermined potential,
the control circuit includes a logic circuit configured to output a logical OR of a signal which is at a low level when the first switch is open and at a high level when the first switch is closed, and the determination signal output by the potential determination circuit, and
the second switch is controlled so that the second switch is open when the logical OR output by the logic circuit is at a high level, and is closed when the logical OR output by the logic circuit is at a low level.

8. The semiconductor integrated circuit of claim 5, wherein
the potential determination circuit outputs a determination signal which is at a low level when the potential of the pseudo-power supply line has reached the predetermined potential and at a high level when the potential of the pseudo-power supply line has not reached the predetermined potential,
the control circuit includes a logic circuit configured to output a logical negated AND of a signal which is at a high level when the first switch is open and at a low level when the first switch is closed, and the determination signal output by the potential determination circuit, and
the second switch is controlled so that the second switch is open when the logical negated AND output by the logic circuit is at a high level, and is closed when the logical negated AND output by the logic circuit is at a low level.
